(19) United States
(12) Patent Application Publication
(10) Pub. No.: US 2004/0202403 A1
(43) Pub. Date: Oct. 14, 2004

(54) Integrated apparatus for processing optical signals

(75) Inventor: Martin Zirngibl, Middletown, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/410,478

(22) Filed: Apr. 9, 2003

(51) Int. Cl. G02B 6/12; G02B 6/28

(52) U.S. Cl. 385/14; 385/24

(57) ABSTRACT

Apparatus for processing optical signals includes an optical multiplexer integrally formed with at least one optical amplifier. The integral formation of the optical multiplexer and the optical amplifier is performed, for example, by monolithic integration on InP. The optical amplifer is connected to an input port of the optical multiplexer to form an amplifying optical multiplexer. Conversely, the optical amplifier can be connected to an output port of the optical multiplexer to form an amplifying optical demultiplexer. The optical amplifiers have specific gain characteristics based upon known lossy characteristics of an optical signal passing through these devices and specific individual control of each optical amplifier.

### FIELD OF INVENTION

This invention relates to the field of optical transmissions systems and, more specifically, to improving the processing of optical signals by use of integrated circuit components.

### BACKGROUND OF INVENTION

One of the problems of wavelength division multiplexed (WDM) systems is that the power per optical channel may not be equal for each channel. As seen in FIG. 1, an unequal power distribution in an optical communication system 100 may arise when a plurality of fixed wavelength optical transmitters 102ₙ that do not produce respective optical signals (at wavelengths λₙ) having the same power level (denoted by unequal length arrows 110) are applied to an optical multiplexer 106. Moreover, the optical multiplexer 106 receiving the optical signals exhibits a different loss at each of its ports. This uneven power distribution causes problems because the weakest channel contains insufficient power to be detected error-free at the receiver (i.e., the receiver experiences a high bit error rate at that channel). Attenuators 104 are commonly used to process some or all of the transmitted output signals to equalize the power levels in each channel (denoted by equal length arrows 112). Unfortunately, such attenuators 104 introduce insertion loss and also add to the cost of the system. Another problem is that discrete component multiplexing introduces substantial of optical loss such that after multiplexing, an optical amplifier 108 is needed after the multiplexer 106 to provide sufficient power to adequately drive the multiplexed signal along a transmission fiber. Uneven power distribution is also attributed to the amplifier 108 having a gain profile is not completely flat (i.e., gain variations between wavelengths). This amplifier also adds cost to the system and imparts noise to the optical signal to be transmitted, thereby reducing the total effectiveness of the system.

Integration of optical communication system components is a possible solution to insertion loss and size problems. One example of fabrication techniques used to create active semiconductive devices in a monolithic configuration is found in U.S. Pat. No. 5,418,183 issued May 23, 1995 to Joyner et al., hereinafter incorporated by reference. This specific reference discloses a tunable filter having a single input and a single output. One example of an optical multiplexer based on InP optoelectronics and an arrayed waveguide grating multiplexer may be found in “PHASAR-Based DDM devices: principles, design and applications), M K Smit, IEEE, J. of Selected Topics in Quantum Electronics, volume 2, No. 2, June 1996 also incorporated by reference. However, there has yet to be found a full implementation of monolithic integration technology to substantially satisfy the specific problems of unequal power distribution and reducing the number of discrete components in such a system.

### SUMMARY OF THE INVENTION

The present invention advantageously provides an apparatus for processing optical signals. In one embodiment of the invention, the apparatus is an amplifying multiplexer that includes a plurality of monolithically formed optical amplifiers each adapted to receive one of a plurality of distinct optical signals and a monolithically formed optical multiplexer. The optical multiplexer has a plurality of inputs and one output such that each of the plurality of optical multiplexer inputs receives an amplified optical signal from plurality of optical amplifiers to produce an optically multiplexed signal at the output. The monolithically formed optical amplifiers are semiconductor amplifiers and in one embodiment are formed of InP. The monolithically formed optical multiplexer is in the configuration of an arrayed waveguide router (AWG) and in one embodiment is also formed of InP. Each of the optical amplifiers have individual gain characteristics that are independently controllable.

The subject invention also includes a monolithically formed amplifying optical demultiplexer of similar design, construction and features as the amplifying multiplexer. Specifically, the invention includes an optical demultiplexer having one input and a plurality of outputs and a plurality of monolithically formed optical amplifiers downstream of the demultiplexer each adapted to receive one of a plurality of distinct optical signals to be applied to a plurality of optical receivers. Each of the plurality of optical demultiplexer outputs are connected respectively to each of the plurality of optical amplifiers for producing the plurality of distinct optical signals from an optically multiplexed signal.

### BRIEF DESCRIPTION OF THE DRAWINGS

The teachings of the present invention can be readily understood by considering the following detailed description in conjunction with the accompanying drawings, in which:

FIG. 1 depicts a prior art transmitter section of the prior art;

FIG. 2 depicts a schematic diagram of a part of an optical transmission system associated with the subject invention;

FIG. 3 depicts a physical characterization of the schematic diagram of the subject invention shown in FIG. 3;

FIG. 4 depicts a second part of an optical transmission system associated with the subject invention; and

FIG. 5 depicts a graph of fiber to fiber transmittance versus wavelength of optical signals transmitted in accordance with the subject invention.

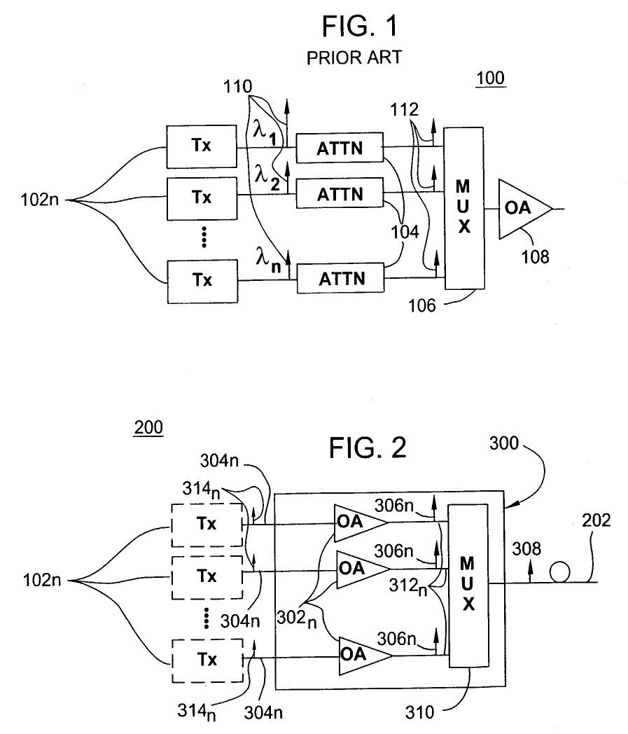

To facilitate understanding, identical reference numerals have been used, where possible, to designate identical elements that are common to the figures.

### DETAILED DESCRIPTION OF THE INVENTION

The subject invention integrates the functionality of optical multiplexing and optical amplification into a single device as described in greater detail below. With such a device, it is possible to maintain better control and signal quality of optical transmissions as well as reduced size, cost and complexity of the overall system.

FIG. 2 depicts a high level block diagram of an integrated optical amplifier/multiplexer according to an embodiment of the subject invention. Specifically, a unitary amplifier/multiplexer 300 is shown in schematic format. Such amplifier/multiplexer 300 finds great utility within the context of a larger optical transmission system 200. The amplifier/multiplexer 300 specifically is placed between a plurality of optical transmitters 102ₙ and a transmission fiber 202 for carrying signals generated by the plurality of transmitters 102ₙ properly amplified and multiplexed by the subject invention for transmission to a distant location.

The amplifier/multiplexer 300 includes a plurality of optical amplifiers 302ₙ arranged parallel to one another. That is, an input end of each of said optical amplifiers 304ₙ is connected to a corresponding transmitter 102ₙ which carries an optical signal generated by said corresponding transmitter 102ₙ (denoted by signal pulses 314ₙ) to each optical amplifier 302ₙ. Each amplifier is specifically designed and configured so as to amplify the signal from its corresponding transmitter 102ₙ in such a manner so as to output a distortion free signal to a multiplexer 310 of a magnitude that is essentially equal to (or within a close proximity to) signals generated and subsequently amplified by other parallel transmitters and amplifiers. Specifically, the output power per amplifier 302 is individually adjusted (i.e. by current control) to provide a plurality of substantially uniform strength amplified signal pulses 306ₙ. In one particular example, the resultant amplified signal pulses 306ₙ outputted from each of the parallel arranged optical amplifiers 302 are in a range of approximately −10 dBm to +10 dBm. Such pulses 306ₙ are subsequently provided to respective input ports 312ₙ of the optical multiplexer 310 where multiplexing operations are performed so as to integrate the plurality of optical signals 306ₙ into a WDM output signal 308 which is transmitted along transmission fiber 202.

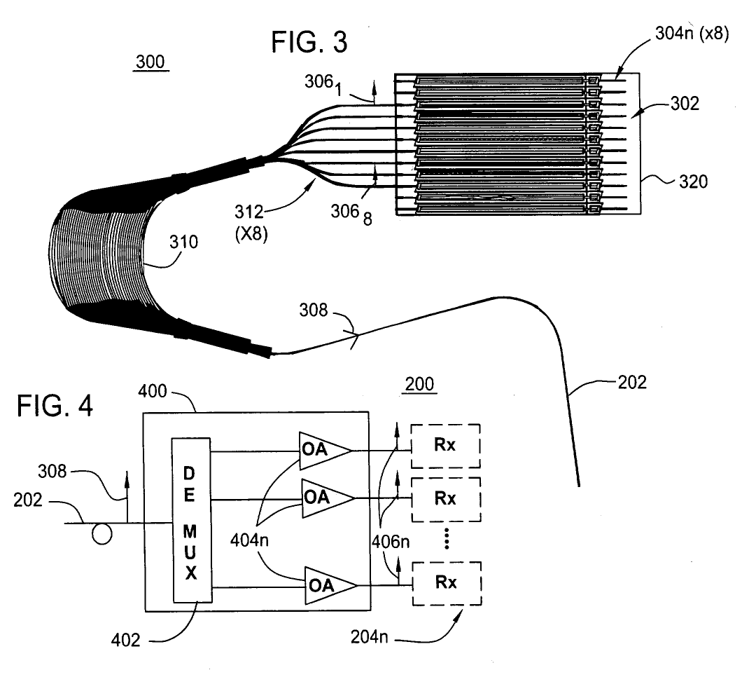

A physical embodiment of the subject invention is depicted in FIG. 3. Specifically, the amplifier/multiplexer 300 is constructed by monolithic techniques. In greater detail, the optical amplifiers 302ₙ are formed on a substrate 320 by monolithic construction techniques to create a series of active semiconductor amplifiers 302ₙ. The output from the substrate 320 is a series of substantially uniformly amplified transmission signals 306ₙ (for sake of clarity only first signal 306₁ and last signal 306₈ are depicted on substrate 320 which contains eight optical amplifiers 302). The optical signals 306ₙ generated by optical transmitters (not shown in this FIG. but represented by 102ₙ in FIG. 2) are applied to input ports 304ₙ for each of said optical amplifiers 302ₙ. Each amplifier is then connected to an input port 312 of the multiplexer 310 to pass the signals 306ₙ therethrough. The multiplexer 310 is shown as an arrayed waveguide grating router (AWG) (such device being know to those skilled in the art). IN one embodiment, the AWG is monolithically integrated on the same substrate 320 as the semiconductor amplifiers 302ₙ. Alternately the AWG may be on a different substrate with the appropriate interconnections therebetween. The AWG performs the necessary multiplexing of optical signals 306ₙ to output the WDM signal 308 along transmission fiber 202. Methods for fabricating optical amplifiers and optical multiplexers are known to those skilled in the art. One skilled in the art may also realize different integration schemes for example, the technique provided in “4-Channel Wavelength Selector Monolithically Integrated On INP”, Electronics Letter, Sep. 17, 1998 by Mestric et al. also incorporated by reference.

While the subject invention has been described and configured for use at the transmitter end of an optically based transmission system such as those seen and described above, the configuration of the subject invention can be reversed so as to be used at the receiver end of such an optical transmission system. One example of such a configuration for a receiver end of the transmission system is depicted in FIG. 4. Specifically, monolithic demultiplexer/optical amplifier 400 finds utility within the context of the aformentioned larger optical transmission system 200 at the receiver. The demultiplexer/optical amplifier 400 is disposed between the fiber optic transmission cable 202 containing the WDM signal 308 and a plurality of optical receivers 204ₙ for converting optical data signals into electronic data pulses. The demultiplexer/amplifier 400 includes a monolithically created demultiplexer 402 (such as an AWG arranged in the opposite configuration as that shown in FIG. 3). The demultiplexer 402 receives the WDM signal 308 and outputs a series of individual wavelength data signals to a plurality of monolithically formed optical amplifiers 404ₙ. The monolithically formed plurality of optical amplifiers 404ₙ are each individually configured so as to have amplifier characteristics that are pre-specified to account for specific losses associated with the individual wavelength to which it is amplifying. Alternately, each of the amplifiers 404ₙ can have individually controllable gain (via current control) to selectively amplify weakly received signals. The plurality of optical amplifiers 404ₙ provides amplified individual wavelength signals 506ₙ of nearly uniform magnitude to a plurality of optical receivers 204ₙ of the larger optical transmission system 200.

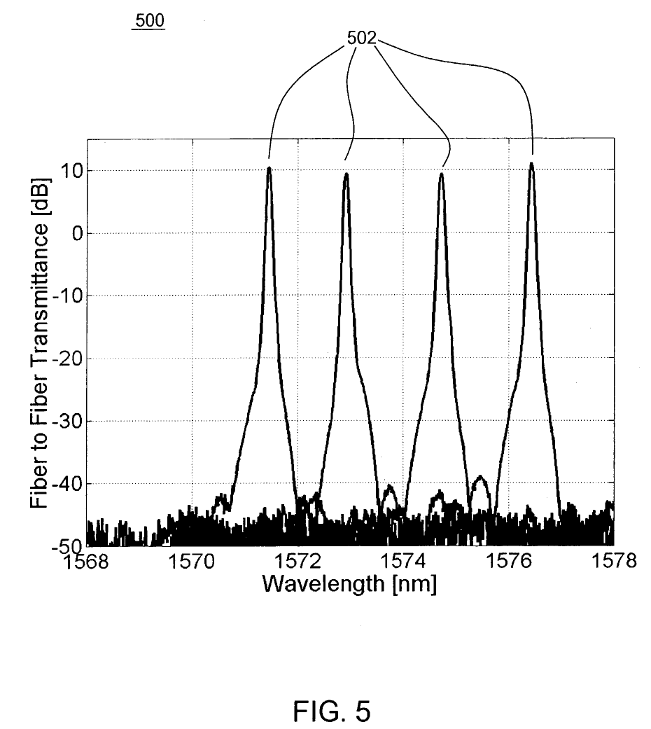

FIG. 5 depicts a graph 500 of fiber to fiber transmittance versus wavelength for the above identified subject invention and the corresponding signals that are either multiplexed 306ₙ or demultiplexed 406ₙ. That is, each of the signals that are either multiplexed 306ₙ or demultiplexed 406ₙ are contained within an individual fiber and propagate along said fiber at a predetermined length. Inspection of the graph 500 indicates that the monolithic apparatus (incorporated into either the transmitter side or receiver side of the optical transmission system 200) of the subject invention contains suitable optical characteristics so that the signals within each of the fibers are transmitted with very little signal loss caused by overlap or interference from adjoining fibers. That is, the wavelength peaks 502 are sufficiently spaced apart from each other that interfiber transmittance does not play a major part in the individual signal characteristics until the strength of said data pulse is significantly at either extreme of its peak 502.

Accordingly, it has been seen and described herein that a monolithically created amplifier/multiplexer or demultiplexer/amplifier contains considerable improvements over past discrete component optical transmission systems. Namely, the subject invention can be built upon a single integrated circuit (IC) which greatly reduces individual component size as well as cost per component as all devices are created at the same time. Additionally, the incorporation of the amplifier with the multiplexer on the single IC greatly reduces the likelihood of signal degradation caused by insertion loss as interconnection between such monolithically formed components is highly improve over interconnection between discrete components.

Although various embodiments that incorporate the teachings of the present invention have been shown and described in detail herein, those skilled in the art can readily devise many other varied embodiments that still incorporate these teachings.

What is claimed is:

1. Apparatus comprising:
a plurality of monolithically formed optical amplifiers each adapted to receive a respective one of a plurality of respective distinct wavelength optical signals;
a monolithically formed optical multiplexer having a plurality of inputs and one output, each of the plurality of inputs receiving an amplified optical signal from each of the plurality of optical amplifiers to produce thereby an optically multiplexed signal at said output.

2. The apparatus of claim 1 wherein the plurality of monolithically formed optical amplifiers are semiconductor amplifiers.

3. The apparatus of claim 2 wherein the semiconductor amplifiers are formed of InP.

4. The apparatus of claim 1 wherein the monolithically formed optical multiplexer is in the configuration of an arrayed waveguide router (AWG).

5. The apparatus of claim 4 wherein the arrayed waveguide router (AWG) is formed of InP.

6. The apparatus of claim 1 wherein each of the optical amplifiers have individual gain characteristics.

7. The apparatus of claim 6 wherein the individual gain characteristics are independently controllable.

8. Apparatus comprising:
a monolithically formed optical demultiplexer, the optical demultiplexer having one input and a plurality of outputs;
a plurality of optical amplifiers monolithically formed downstream of the demultiplexer, each of the plurality of optical amplifiers adapted to receive one of a plurality of distinct optical signals to be applied to a plurality of optical receivers; each of the plurality of optical demultiplexer outputs connected respectively to each of the plurality of optical amplifiers for producing the plurality of distinct optical signals from an optically multiplexed signal.

9. The apparatus of claim 8 wherein the plurality of monolithically formed optical amplifiers are semiconductor amplifiers.

10. The apparatus of claim 9 wherein the semiconductor amplifiers are formed of InP.

11. The apparatus of claim 8 wherein the monolithically formed optical demultiplexer is in the configuration of an arrayed waveguide router (AWG).

12. The apparatus of claim 11 wherein the arrayed waveguide router (AWG) is formed of InP.

13. The apparatus of claim 8 wherein each of the optical amplifiers have individual gain characteristics.

14. The apparatus of claim 13 wherein the individual gain characteristics are independently controllable.
